(19) United States
(12) Patent Application Publication
(10) Pub. No.: US 2018/0193871 A1
(43) Pub. Date: Jul. 12, 2018

(54) DEVICE FOR CONVEYING VISCOUS MATERIAL

(71) Applicant: Atlas Copco IAS GmbH, Bretten (DE)

(72) Inventors: Patrick SCHOLL, Ellhofen (DE); Sven WIRTH, Weil der Stadt (DE)

(73) Assignee: Atlas Copco IAS GmbH, Bretten (DE)

(21) Appl. No.: 15/744,185

(22) PCT Filed: May 10, 2016
(86) PCT No.: PCT/EP2016/060394

§ 371 Date: Jan. 12, 2018

(30) Foreign Application Priority Data
Jul. 20, 2015 (DE) 10 2015 009 130.1

(51) Int. Cl. B05C 5/02; B05B 9/047

(52) U.S. Cl. CPC B05C 5/0225; B05B 9/047

(57) ABSTRACT

A device for conveying viscous material out of a barrel-like container which has a container base and a container shell which extends upward from the container base, having a follower plate for closing off the container. The follower plate having a material outlet opening and a ventilation opening. There is a pump for conveying the viscous material through the material outlet opening, and a ventilation device for introducing compressed air through the ventilation opening, and a lowering device for lowering the follower plate in the container. A discharge valve is provided which, in a first switching position, blocks a line which leads out of the first pressure chamber, and which, in a second switching position, opens the line for the purposes of discharging pressure medium out of the first pressure chamber.

The invention relates to an apparatus for conveying viscous material out of a barrel-like container, which has a container base and a container shell that extends upward from the container base, having a follower plate for closing off the container, which plate, lying against the inner surface of the container shell that faces the container interior, can be moved in a direction toward the container base and away from the container base, and which plate has a material outlet opening and a ventilation opening; having a pump for conveying the viscous material through the material outlet opening and a ventilation device for introducing compressed air through the ventilation opening; and having a lowering device for lowering the follower plate in the container, which device has at least one dual-action cylinder having two pressure chambers that are delimited from one another, in pressure-tight manner, by means of a piston; and having a support device that supports the follower plate, wherein the piston is connected with the support device by means of a piston rod that runs through a first of the pressure chambers and is led axially out of the cylinder, in such a manner that the first pressure chamber is reduced in size when the follower plate is raised in the direction away from the container base.

Such apparatuses are used, for example, for applying adhesives or sealants in the production of motor vehicles. In this regard, the viscous material is conveyed out of the barrel-like container by means of the pump, wherein the follower plate is constantly kept in contact against a surface of the material in the container by means of the lowering device. The follower plate is sealed off relative to the container shell, so that on the one hand, no material can get out of the container, and on the other hand, no air from the surroundings can penetrate into the container. Once the container is emptied, it is replaced with a new, full container. For this purpose, the follower plate must be moved upward out of the container. In order to be able to move the follower plate upward in the container, the interior of the container must be ventilated, since otherwise, a vacuum occurs in the container, which prevents the follower plate from being moved out. For this purpose, air, particularly compressed air, is introduced into the container through the ventilation opening in the follower plate, by means of the ventilation device. Since the follower plate has a large surface area in comparison with the surfaces of the piston, introduction of compressed air into the container is an effective means for forcing the follower plate upward. When the follower plate is moved upward, the piston rigidly connected with it by way of the support device and the piston rod also moves upward, so that an excess pressure occurs in the first pressure chamber, and a partial vacuum occurs in the second pressure chamber. The operator charged with the container replacement must therefore ensure pressure equalization by means of discharging pressure medium from the first pressure chamber and introducing pressure medium into the second pressure chamber. This requires some attentiveness. In this regard, it can happen that in the event of inattentiveness of the operator, the pressure medium in the first pressure chamber is compressed so greatly that when the follower plate exits from the container, when the excess pressure in the container produced by the ventilation device escapes, the pressure medium in the first pressure chamber acts like a tensed spring and the follower plate presses into or onto the container again with great force. In this regard, the container can be damaged, or the operator can actually be injured.

It is therefore the task of the invention to develop an apparatus of the type stated initially further, in such a manner that it is safe to handle.

This task is accomplished, according to the invention, by means of an apparatus having the characteristics of claim 1, alternatively by means of an apparatus having the characteristics of claim 10. Advantageous further developments of the invention are the object of the dependent claims.

The invention is based on the idea of not leaving it to the attentiveness of the operator that the pressure in a first pressure chamber is reduced to a sufficient degree during an upward movement of the piston, caused by raising of the follower plate. For this purpose, a discharge valve is provided, which blocks a line that leads out of the first pressure chamber in one switching position and opens the line in another switching position, to discharge pressure medium from the first pressure chamber. It is advantageous if a control unit automatically switches the discharge valve before the introduction of compressed air through the ventilation opening or during this introduction. In this regard, the discharge valve is preferably a throttle valve, or a throttle valve precedes it, so that the pressure medium cannot suddenly escape from the first pressure chamber.

Switching of the discharge valve can take place automatically even before the introduction of compressed air into the container, for example when the apparatus is switched from pump operation to container replacement operation by the operator. In this regard, a corresponding signal is automatically transmitted to the control unit, which then switches the discharge valve. However, it is also possible that the introduction of compressed air into the container takes place by means of switching a valve in a compressed air feed line, and that switching the valve in the compressed air feed line generates a signal to the control unit, and this unit switches the discharge valve when it receives this signal. The line can lead out of the first pressure chamber to an end that is open to the surroundings, by way of the discharge valve.

According to an advantageous further development of the invention, the line leads out of the first pressure chamber, from the discharge valve, into the second pressure chamber, so that the two pressure chambers are short-circuited when the discharge valve is in its second switching position. Discharge of pressure medium from the first pressure chamber then brings about feed of pressure medium into the second pressure chamber. No additional measures then have to be taken to prevent the occurrence of a partial vacuum in the second pressure chamber. It is practical if a kickback valve is disposed in the line between the discharge valve and the second pressure chamber, which releases a flow of the pressure medium into the second pressure chamber in a switching position, and blocks a flow of the pressure medium out of the second pressure chamber.

Alternatively, the task underlying the invention is accomplished by an apparatus having the characteristics of claim 10. According to claim 10, at least one pressure measurement element for detection of the pressure in the first and/or in the second pressure chamber, and a regulation device for regulation of the compressed air feed through the ventilation opening as a function of the pressure in the first pressure chamber and/or as a function of the pressure in the second pressure chamber are provided. Each of the pressure measurement elements can be, in particular, a pressure sensor for measuring the pressure in the respective pressure chamber. The pressure in the first and/or in the second pressure chamber can be adapted by discharge or introduction of pressure medium by means of the regulation device. In this regard, it is advantageous if the regulation device has a regulation valve that can be switched for discharge of pressure medium from the first pressure chamber and/or introduction of pressure medium into the second pressure chamber as a function of the pressure in the first pressure chamber and/or of the pressure in the second pressure chamber. In particular, it is possible that the regulation device interrupts the introduction of compressed air when the pressure in the first pressure chamber rises above a first threshold value, and then releases discharge of pressure medium out of the first pressure chamber. Alternatively or supplementally to this, the regulation device can interrupt the introduction of compressed air when the pressure in the second pressure chamber drops below a second threshold value. In each case, the regulation device can furthermore release the introduction of pressure medium into the second pressure chamber.

According to an advantageous further development, the regulation device releases the introduction of compressed air into the container once again when the pressure in the first pressure chamber drops below a third threshold value, and then also blocks discharge of pressure medium out of the first pressure chamber. Alternatively or supplementally to this, the regulation device can release the introduction of compressed air once again when the pressure in the second pressure chamber rises above a fourth threshold value, and the regulation device can then block the introduction of pressure medium into the second pressure chamber.

In the following, the invention will be explained in greater detail using three schematically represented exemplary embodiments. The figures show:

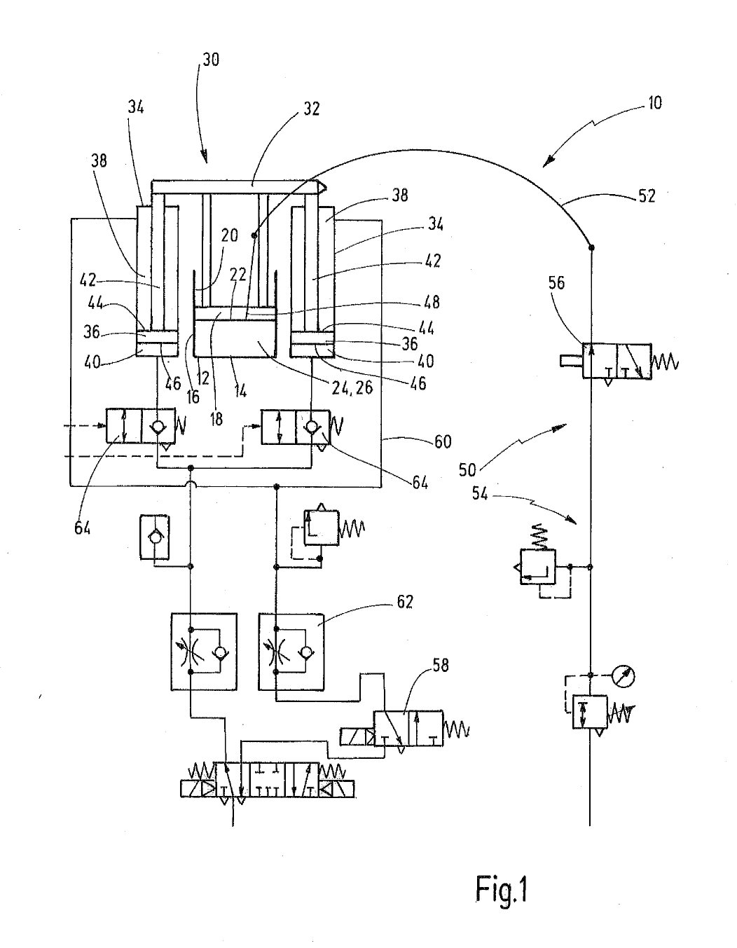

FIGS. 1 to 3, in each instance, an apparatus for conveying viscous material, in a schematic representation, according to a first, a second, and a third exemplary embodiment.

In FIGS. 1, 2, 3, an apparatus 10, 110, 210 for conveying viscous material out of a cylindrical container 12, which has a container base 14 and a container shell 16 that extends upward from the container base 14 is shown schematically, in each instance. The conveying apparatus 10, 110, 210 (the same characteristics are provided with the same reference symbols, in each instance, in all the exemplary embodiments) has a follower plate 18, which, lying against an inner surface 20 of the container shell 16, in sealing manner, lies against a surface 22 of the viscous material 26 contained in the container interior 24. The follower plate 18 has a material outlet opening, not shown in any detail, to which a pump is connected, which conveys the viscous material, generally an adhesive or sealant, to an application apparatus. During the course of conveying, the amount of the viscous material in the container 12 decreases, so that the follower plate 18 is gradually-moved downward, in order to be kept in contact with the surface 22 of the viscous material 26.

For this purpose, a lowering device 30 is provided, which has a support device 32 that is rigidly connected with the follower plate 18. Furthermore, it has two dual-action cylinders 34, which have the same construction and are disposed on both sides of the follower plate 18, so that their center axes lie in a line with the center axis of the follower plate 18. The cylinders 34 each have a piston 36, which delimits a first, upper pressure chamber 38 and a second, lower pressure chamber 40 from one another in pressure-tight manner. A piston rod 42 runs through the first pressure chamber 38, in each instance, which rod is passed out of the cylinder 34 axially, in sealed manner, wherein the two piston rods 42 are rigidly connected with the support device 32. The pistons 36, and with them the follower plate 18, can be moved up and down by means of the introduction of pressure medium such as compressed air or hydraulic fluid into the pressure chambers 38, 40, particularly in order to follow the decreasing material level in the container 12. The first pressure chambers 38 communicate with one another, as do the second pressure chambers 40.

The first active surface 44 of the piston 36, which faces the first pressure chamber 38, in each instance, is smaller than the second active surface 46 that faces the second pressure chamber 40. At the same pressure in the two pressure chambers 38, 40, a resulting upward force occurs that approximately equalizes the weight of the follower plate 18, of the support device 32, of the piston rods 42, and of the pistons 36 with a tolerance of less than 10%, preferably of less than 5%.

The follower plate 18 has a ventilation opening 48, by way of which air and, in particular, compressed air can be introduced into the container interior 24. The ventilation device 50 is provided for this purpose; it has a compressed air line 52 that runs to the ventilation opening 48, which line is connected with a compressed air system 54 and can be blocked off by means of compressed air valve 56. If the container 12 has been emptied, the follower plate 18 must be removed from it for container replacement. Since this plate lies tightly against the inner surface 20, air must be introduced into the container interior by way of the ventilation opening 48, since otherwise, raising of the follower plate by means of the lowering device 30 would lead to raising of the container 12. The introduction of compressed air into the container interior 24 is furthermore utilized to raise the follower plate 18, since its surface area that faces the container interior 24 is large in comparison with the active surfaces 44, 46 of the pistons 36, and thereby a great force can already be achieved at a low pressure. In order to prevent compression of the pressure medium in the first pressure chamber 38, the measures described below are provided according to the three exemplary embodiments.

In the first exemplary embodiment (FIG. 1), a discharge valve 58 is provided in a line 60 that leads to the first pressure chambers 38, which valve blocks the line 60 in a first switching position and opens it up to the surroundings in a second switching position, as shown in FIG. 1. When the container is replaced, the discharge valve 58 is brought into the second switching position before or along with ventilation of the container interior 24, so that pressure medium can escape from the first pressure chambers 38 into the surroundings when the follower plate 18 is moved upward. Switching of the discharge valve 58 into the second switching position can take place manually, for example, wherein a control device or regulation device blocks ventilation of the container interior 24 as long as the discharge valve 58 is in its first switching position. Switching of the discharge valve 58 into the second switching position can, however, also take place automatically by means of a control unit when the conveying apparatus 10 is switched from a conveying mode, in which it is ready to convey material 26 out of the container 12, into a container replacement mode, in which material conveyance is stopped and an upward movement of the follower plate 18 is released. There is also a throttle valve 62 in the line 60, ahead of the discharge valve 58.

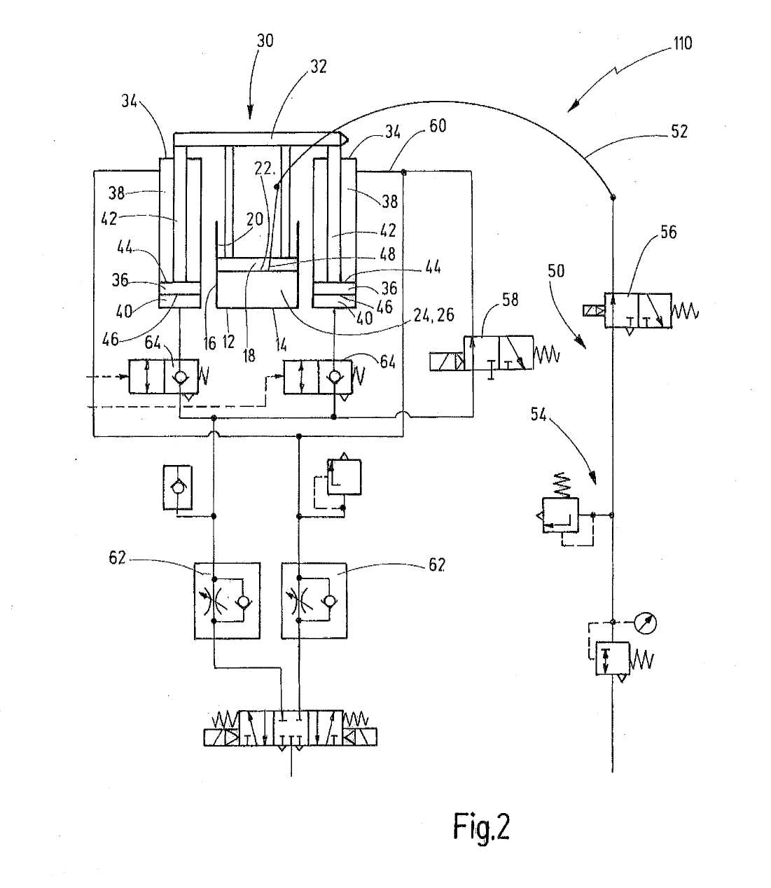

In the second exemplary embodiment (FIG. 2), the line 60, in which the discharge valve 58 is disposed, runs between the two pressure chambers 38, 40. To replace the container, the discharge valve 58 is brought into its second switching position, as described in connection with the first exemplary embodiment, so that a bypass is produced between the pressure chambers 38, 40. When the follower plate 18 is moved upward, pressure medium is displaced out of the first pressure chambers 38 into the second pressure chambers 40. In order to prevent a return flow of pressure medium, a kickback valve 64 is disposed between the discharge valve 58 and each of the two pressure chambers 40.

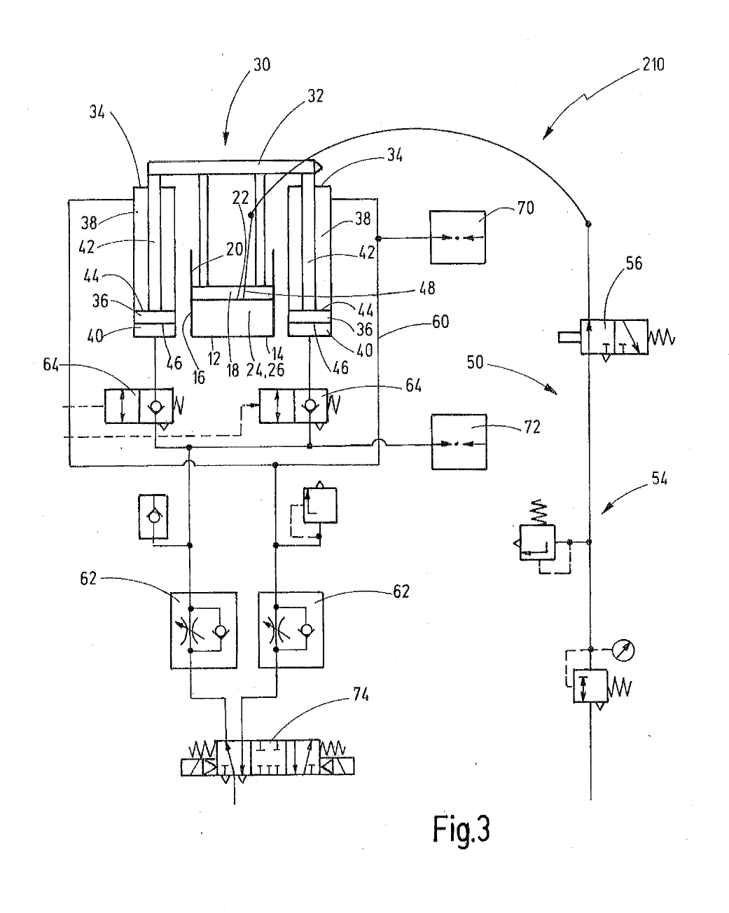

In the third exemplary embodiment (FIG. 3), a first pressure sensor 70 for measuring the pressure in the first pressure chambers 38 and a second pressure sensor 72 for measuring the pressure in the second pressure chambers 40 is provided, the measurement values of which are transmitted to a regulation device, not shown in any detail. To raise the follower plate 18, compressed air is introduced into the container 12 by means of the ventilation device 50. During the resulting movement of the follower plate 18 and of the piston 36 upward, the pressure in the first pressure chamber 38 increases, while the pressure in the second pressure chamber 40 drops. As soon as the pressure measured by the first pressure sensor 70 increases above a predetermined first threshold value or the pressure measured by the second pressure sensor 72 drops below a predetermined second threshold value, the regulation device stops feed of compressed air into the container interior 24 and switches a regulation valve 74 into its switching position shown in FIG. 3, in which pressure medium is discharged from the first pressure chamber 38 and pressure medium is introduced into the second pressure chamber 40. If the pressure measured by the first pressure sensor 70 drops below a predetermined third threshold value, or if the pressure measured by the second pressure sensor 72 increases above a predetermined fourth threshold value, the regulation device switches the regulation valve 74 back into its blocking position, in which introduction and discharge of pressure medium into and out of the pressure chambers, respectively, are blocked, and releases feed of compressed air into the container interior 24 once again. This process is repeated until the follower plate 18 has been removed from the container 12.

In FIG. 3, the reference symbols 70, 72 can also refer to pressure switches, alternatively to the above description, which switches switch the regulation valve 74 as described in order to reach the aforementioned threshold values, without a separate regulation device being required. The pressure switches 70, 72 thereby combine the functions of a pressure measurement element and of a regulation device with one another, in each instance.

In summary, the following should be stated. The invention relates to an apparatus 10, 110, 210 for conveying viscous material 26 out of a barrel-like container 12, which has a container base 14 and a container shell 16 that extends upward from the container base 14, having a follower plate 18 for closing off the container 12, which plate, lying against the inner surface 20 of the container shell 16 that faces the container interior 24, can be moved in a direction toward the container base 14 and away from the container base 14, and which plate has a material outlet opening and a ventilation opening 48; having a pump for conveying the viscous material 26 through the material outlet opening and a ventilation device 50 for introducing compressed air through the ventilation opening 48; and having a lowering device 30 for lowering the follower plate 18 in the container 12, which device has at least one dual-action cylinder 34 having two pressure chambers 38, 40 that are delimited from one another, in pressure-tight manner, by means of a piston 36; and having a support device 32 that supports the follower plate 18, wherein the piston 36 is connected with the support device 32 by means of a piston rod 42 that runs through a first of the pressure chambers 38 and is led axially out of the cylinder 34, in such a manner that the first pressure chamber 38 is reduced in size when the follower plate 18 is raised in the direction away from the container base 14. According to the invention, a discharge valve 58 is provided, which blocks a line 60 that leads out of the first pressure chamber 38 in a first switching position and opens the line 60 in a second switching position, to discharge pressure medium from the first pressure chamber 38.

1. Apparatus for conveying viscous material (26) out of a barrel-like container (12), which has a container base (14) and a container shell (16) that extends upward from the container base (14), having a follower plate (18) for closing off the container (12), which plate, lying against the inner surface (20) of the container shell (16) that faces the container interior (24), can be moved in a direction toward the container base (14) and away from the container base (14), and which plate has a material outlet opening and a ventilation opening (48); having a pump for conveying the viscous material (26) through the material outlet opening and a ventilation device (50) for introducing compressed air through the ventilation opening (48); and having a lowering device (30) for lowering the follower plate (18) in the container (12), which device has at least one dual-action cylinder (34) having two pressure chambers (38, 40) that are delimited from one another, in pressure-tight manner, by means of a piston (36); and having a support device (32) that supports the follower plate (18), wherein the piston (36) is connected with the support device (32) by means of a piston rod (42) that runs through a first of the pressure chambers (38) and is led axially out of the cylinder (34), in such a manner that the first pressure chamber (38) is reduced in size when the follower plate (18) is raised in the direction away from the container base (14), comprising a discharge valve (58) that blocks a line (60) that leads out of the first pressure chamber (38) in a first switching position and opens the line (60) in a second switching position, to discharge pressure medium from the first pressure chamber (38).

2. Apparatus according to claim 1, comprising a control unit for automatic switching of the discharge valve (58) into the second switching position before or during the introduction of compressed air through the ventilation opening (48).

3. Apparatus according to claim 1, wherein the discharge valve (58) is a throttle valve or that a throttle valve (62) precedes it.

4. Apparatus according to claim 1, wherein the line (60) leads from the discharge valve (58) to an end that is open to the surroundings.

5. Apparatus according to claim 1, wherein the line (60) leads from the discharge valve (58) into the second pressure chamber (40).

6. Apparatus according to claim 5, wherein a kickback valve (64) is disposed in the line (60) between the discharge valve (58) and the second pressure chamber (40), which releases a flow of the pressure medium into the second pressure chamber (40) in a switching position, and blocks a flow of the pressure medium out of the second pressure chamber (40).

7. Method for removing the follower plate (18) of an apparatus (10, 110) according to claim 1 from a barrel-like container (12), which has a container base (14) and a container shell (16) that extends upward from the container base (14), wherein compressed air is introduced into the container (12) by means of the ventilation device (50), by way of the ventilation opening (48), and wherein the follower plate (18) is moved upward, away from the container base (14), by the air pressure in the container (12), wherein the discharge valve (58) is switched and brought into the second switching position before or along with the introduction of compressed air into the container (12).

8. Method according to claim 7, wherein the discharge valve (58) is automatically switched by means of a control unit.

9. Method according to claim 8, wherein the introduction of compressed air into the container (12) takes place by means of switching a valve (56) in a compressed air feed line (52), and that switching of the valve (56) in the compressed air feed line (52) generates a signal to the control unit, and this unit switches the discharge valve (58) when it receives the signal.

10. Apparatus for conveying viscous material (26) out of a barrel-like container (12), which has a container base (14) and a container shell (16) that extends upward from the container base (14), having a follower plate (18) for closing off the container (12), which plate, lying against the inner surface (20) of the container shell (16) that faces the container interior (24), can be moved in a direction toward the container base (14) and away from the container base (14), and which plate has a material outlet opening and a ventilation opening (48); having a pump for conveying the viscous material (26) through the material outlet opening and a ventilation device (50) for introducing compressed air through the ventilation opening (48); and having a lowering device (30) for lowering the follower plate (18) in the container (12), which device has at least one dual-action cylinder (34) having two pressure chambers (38, 40) that are delimited from one another, in pressure-tight manner, by means of a piston (36); and having a support device (32) that supports the follower plate (18), wherein the piston (36) is connected with the support device (32) by means of a piston rod (42) that runs through a first of the pressure chambers (38) and is led axially out of the cylinder (34), in such a manner that the first pressure chamber (38) is reduced in size when the follower plate (18) is raised in the direction away from the container base (14), comprising at least one pressure measurement element (70, 72) for detection of the pressure in the first and/or in the second pressure chamber (38, 40), and a regulation device for regulation of the compressed air feed through the ventilation opening (48) as a function of the pressure in the first pressure chamber (38) and/or as a function of the pressure in the second pressure chamber (40).

11. Apparatus according to claim 10, wherein the regulation device has a regulation valve (74) that can be switched for discharge of pressure medium from the first pressure chamber (38) and/or introduction of pressure medium into the second pressure chamber (40) as a function of the pressure in the first pressure chamber (38) and/or of the pressure in the second pressure chamber (40).

12. Method for removing the follower plate (18) of an apparatus (210) according to claim 10 from a barrel-like container (12), which has a container base (14) and a container shell (16) that extends upward from the container base (14), wherein compressed air is introduced into the container (12) by means of the ventilation device (50), by way of the ventilation opening (48), and wherein the follower plate (18) is moved upward, away from the container base (14), by the air pressure in the container (12), characterized in that the regulation device interrupts the introduction of compressed air when the pressure in the first pressure chamber (38) rises above a predetermined first threshold value and/or when the pressure in the second pressure (40) chamber drops below a predetermined second threshold value, and releases the discharge of pressure medium from the first pressure chamber (38) and/or the introduction of pressure medium into the second pressure chamber (40).

13. Method according to claim 12, wherein the regulation device releases the introduction of compressed air once again when the pressure in the first pressure chamber (38) drops below a predetermined third threshold value and/or when the pressure in the second pressure chamber (40) rises above a predetermined fourth threshold value, and blocks the discharge of pressure medium out of the first pressure chamber (38) and/or the introduction of pressure medium into the second pressure chamber (40).
